(19) United States
(12) Patent Application Publication
(10) Pub. No.: US 2011/0028579 A1
(43) Pub. Date: Feb. 3, 2011

(54) PROCESS FOR LIGHTENING THE COLOR OF POLYISOCYANATES WITH OZONE-CONTAINING GAS

(75) Inventors: Michael Zoellinger, Dresden (DE); Johannes Adam, Dresden (DE); Markus Kraemer, Radeburg (DE); Johannes Jacobs, Ossendrecht (NL); Oliver Bey, Niederkirchen (DE); Peter Zehner, Weisenheim am Berg (DE); Walter Van Gysel, Halen (BE); Claudia Huang Ruobin, Shanghai (CN); Matthias Kroner, Eisenberg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASE SE, Ludwigshafen (DE)

(21) Appl. No.: 12/936,042

(22) PCT Filed: Mar. 31, 2009
(86) PCT No.: PCT/EP2009/053812

§ 371 Date: Oct. 1, 2010

(30) Foreign Application Priority Data
Apr. 1, 2008 (EP) 08153925.6

(51) Int. Cl. C08J 9/36; C08J 9/10

(52) U.S. Cl. 521/88; 521/96; 521/95

(57) ABSTRACT

The continuous or quasi-continuous process for lightening organic polyisocyanates with ozone-containing gas, the treatment of the organic polyisocyanate being effected with an ozone-containing gas which furthermore comprises at least one further inert and/or reactive gas can be carried out, according to the invention, in a stirred tank with connected storage tank, in a sieve tray column or in a packed column.

The present invention relates to a process for lightening the color of organic aromatic polymeric isocyanates, in which an ozone-containing gas is used.

Polyisocyanates are prepared in large amounts and are reacted with polyalcohols, such as, for example, ethylene glycol or glycerol, in a polyaddition reaction to give polyurethanes. Depending on the polyisocyanate component and the polyol component and the preparation conditions, polyurethanes may be hard and brittle or soft and resilient. They are of considerable industrial importance and have a broad application spectrum. Polyurethanes are used, for example, as polyurethane finishes, potting compounds or foams.

Diisocyanates can be prepared, inter alia, by reacting phosgene with the corresponding diamines. Inter alia, the following aryl and alkyl diisocyanates are of industrial importance: methylenediphenylene diisocyanate (diphenylmethane diisocyanate, MDI), polymeric methylenediphenylene diisocyanate (PMDI), toluene diisocyanate (2-methyl-1,3-phenylene diisocyanate, TDI), naphthylene diisocyanate (NDI), hexamethylene diisocyanate (HDI) and isophorone diisocyanate (isocynatotrimethylisocyanatomethylcyclohexane, IPDI).

Polymeric methylenediphenylene diisocyanate (PMDI) is prepared, for example, by phosgenation of 4,4′-diaminodiphenylmethane (methylenedianiline, MDA), for example phosgene being dissolved in a solvent, such as chlorobenzene, and MDA being added to it at elevated temperature. The monomeric methylenediphenylene diisocyanate (MMDI) formed, inter alia, thereby can be partly separated off by distillation. The bottom product is referred to as polymeric methylenediphenylene diisocyanate (PMDI) and as a rule also comprises MMDI, higher oligomers, the isomers thereof and small proportions of uretdiones, uretonimines and urea.

A problem in the preparation of polyisocyanates is the discoloration of the bottom product owing to the thermal load during the separation by distillation. PMDI having a dark discoloration leads to polyurethane products having poor optical properties. The color of isocyanates can be characterized by various methods known to the person skilled in the art, for example using the so-called L,a,b values, according to the CIE color system or the iodine color number.

The prior art discloses a plurality of processes in which monomeric and polymeric isocyanates were treated with ozone for color improvement.

DE A-4215746 describes a process in which exclusively aliphatic isocyanates are treated with pure oxygen, with air and with admixtures of up to 20% by volume of ozone in a continuously operated stirred tank. The process was varied with regard to reaction temperature and duration of the reactions.

JP 08291129 discloses a process for lightening the color of polymeric aromatic isocyanates, inter alia also PMDI being treated with ozone in a bubble column. However, the resulting lightening of color is small, inter alia owing to the insufficient dispersing of the ozone-containing gas. The properties of the polyurethane end product are not described in the document.

It has been found that the dispersing of the reaction gas in the mixture comprising the isocyanate is of decisive importance for the ozone reaction and thus considerably influences the lightening effect achieved in the isocyanate. An object of the invention is to lighten aromatic polymeric isocyanates by a suitable process. Furthermore, no chain degradation should take place and the content of isocyanate groups should not be reduced. Likewise, the physical and in particular mechanical properties of the resulting polyurethane products should not be adversely affected by the treatment. Moreover, the process should be capable of being carried out continuously or quasi-continuously and it should permit reaction of a sufficient amount of polyisocyanate. The process should achieve high conversion of ozone and lighten the color to as great an extent as possible by improved dispersing of an ozone-containing gas.

The abovementioned objects are achieved by a process for lightening organic polyisocyanates with an ozone-containing gas, in which the treatment of the organic polyisocyanate can be carried out or is carried out continuously or quasi-continuously.

It was found that, in particular ozone-containing gas mixtures with nitrogen, oxygen and/or oxides of nitrogen, can be surprisingly well dispersed in PMDI. Particularly suitable is a mixture of nitrogen, oxygen, ozone and nitrogen oxide. The treatment with an ozone-containing gas is often effected in such a way that, in addition to ozone, furthermore at least one further inert gas (such as nitrogen) and/or reactive gas (such as NO) is present in the gas mixture. It is particularly suitable if the lightening process according to the invention for polyisocyanates is carried out in the following apparatuses:
a) stirred tank having a connective storage tank
b) tray column, e.g. sieve tray column
c) packed column.

The invention in particular relates to a process for lightening organic polyisocyanates with ozone-containing gas, wherein the treatment of the organic polyisocyanate being effected with an ozone-containing gas which furthermore comprises at least one further inert and/or reactive gas. Thereby the process can be carried out continuously or quasi-continuously.

Preferably, the treatment of the organic polyisocyanate can be carried out in a stirred tank with connected storage tank.

The treatment of the organic polyisocyanate can for example be carried out in a tray column. The treatment of the organic polyisocyanate can for example be carried out in a packed column.

Treatment of the organic polyisocyanate is preferably carried out with a gas mixture comprising nitrogen, oxygen, ozone and oxides of nitrogen.

A working gas consisting of oxygen and nitrogen is preferably used as starting material for producing the ozone-containing gas. A working gas consisting of 20% of oxygen and 80% of nitrogen is often used as starting material for producing the ozone-containing gas.

The treatment of the organic polyisocyanate is carried out e.g at temperatures of from 15° C. to 100° C. The energy input of the stirring unit is preferably from 0.1 to 50 kW/m³.

Preferably a continuous circulation takes place between the stirred tank and the storage tank.

The treatment of the polyisocyanate preferably takes place in a stirred tank in which less than 50% of the volume of the stirred tank is filled with polyisocyanate.

Preferably surface aeration is effected during the treatment of the polyisocyanate.

The invention also relates to an organic polyisocyanate obtainable by a process as described. The invention also relates to a polyurethane obtainable by reacting the polyisocyanate with an aliphatic or aromatic polyalcohol. The invention also relates to a polyurethane obtainable by reacting the polyisocyanate with an aliphatic polyalcohol.

The invention also relates to a shaped article comprising polyurethane as described. The invention also relates to a use of an organic polyisocyanate for the preparation of a rigid polyurethane foam.

It was also found to be advantageous if strong surface aeration is achieved in the case of the polyisocyanate, for example by a stirred tank with strong stirrer and/or only partial filling of the stirred tank. In a continuous mode of operation of the treatment of the polyisocyanates, the reaction materials flowed through the reaction apparatus (substantially) without interruption as a function of time, and a product stream is removed continuously. In a quasi-continuous mode of operation, a continuous product stream resulting at least for a certain time is achieved, for example, by parallel reaction apparatuses or by one or more storage containers.

With the process according to the invention, it is possible to achieve flow rates of polyisocyanate of about 60 tonnes/hour, in particular from 5 to 30 t/h. It has been found that good dispersing is obtained and at the same time large amounts of polyisocyanate can be treated if a stirred tank is combined with a storage tank and the PMDI is pumped (for example by means of pumps) in a circulation process through the reactor. A continuous circulation of the reaction mixture takes place between stirred tank and storage tank. The storage tank should preferably have an apparatus for homogenization and should have a volume which corresponds to 0.5 to 100 times, preferably 5 to 10 times, the volume of the stirred tank.

In the process according to the invention, the energy input of the stirrer in the stirred tank is preferably from 0.1 to 50 kW/m³, in particular from 0.5 to 10 kW/m³, very particularly preferably from 1 to 5 kW/m³. Correspondingly high stirrer speeds produce good dispersing of the gas of the reaction medium and a high ozone conversion. The advantage of a high energy input by the stirrer is evident, for example, from the high ozone conversions of from 90% to 95%. Possible embodiments of the stirrers are in particular turbine stirrers or paddle stirrers (e.g. four-paddle stirrers). Furthermore, baffles can optionally be provided in the stirred tank.

A stirred tank in which less than 50% of the volume, in particular 30% of the volume, are filled with the polyisocyanate can be used as one embodiment of the invention. By vigorous stirring, large surface modification of the liquid polyisocyanate and hence good surface aeration can be achieved. In a continuous process, a successful treatment can also be achieved with a degree of filling of from 5 to 90%.

A further possibility is to use columns as reaction spaces. It has been found that bubble columns without trays have as a rule a lower efficiency with regard to lightening of the color and ozone conversion. With the use of tray columns having permeable trays and overflows, in particular of sieve tray columns, it was possible to convert the ozone virtually completely. With completely filled packed columns with minimized back-mixing, it was possible to achieve results comparable with those of the sieve tray column.

It has been found that the reaction temperature in all three preferred embodiments should be in the range from 15° to 100° C., temperature ranges from 30° to 60° C. and in particular from 30° to 40° C. having proven particularly suitable.

For example, pure oxygen is suitable as a working gas for the ozone production, but oxygen with admixtures of nitrogen is preferably used. A working gas having a proportion of from 0.5 to 20%, in particular from 1 to 10%, of oxygen and a proportion of from 80 to 99.5%, in particular from 90 to 99%, of nitrogen is preferably used. In the production of ozone (for example by silent electrical discharge), certain proportions of oxides of nitrogen also form in the case of admixed nitrogen, which in turn have high oxidizing power and can destroy colored bodies. The color lightening effect achieved is promoted by the oxides of nitrogen formed.

The ozone concentrations used are as a rule in the range from 5 to 150 g/m³, concentrations of 100-120 g/m³ having proven useful. The amount of oxygen used is in particular 1-5 m³ per 1000 kg of polyisocyanate, in particular PMDI, and the amount of ozone introduced is, for example, 50-500 g of ozone per 1000 kg of polymer, in particular PMDI. In continuous or quasi-continuous operation, an amount of ozone of from 100 to 400 mg/kg of PMDI has proven advantageous, in particular from 200 to 300 mg/kg of PMDI. The amount of nitrogen introduced was preferably chosen so that the gas mixture comprised not more than 20% of oxygen on leaving the reaction space. The emerging gas mixture is as a rule worked up, for example subjected to deozonization.

The isocyanates used and the lightened isocyanates obtainable by means of the process described above were characterized with regard to the content of isocyanate groups (NCO groups) and the color. The lightened products can be stored or directly further processed.

The invention also relates to the various apparatuses for carrying out the process described above for lightening polyisocyanates. The invention also relates to the polyisocyanate product which is obtainable (or obtained) by the process described and which can be characterized, for example, by the features described below.

The content of isocyanate groups (NCO groups) in % (percent by weight of NCO) was determined by conventional methods, for example according to the standard DIN 53285. The determination of the content of isocyanate groups before and after the lightening process showed that the treatment with an ozone-containing gas results in no significant change in the isocyanate groups.

The color or the chromaticity coordinate of the polyisocyanates was characterized by the L*, a* and b* values according to CIELAB (also mentioned below as L, a and b values for short) and by the iodine color number according to DIN 6162. In the CIELAB color system, the three parameters L, a and b are used for determining the chromaticity coordinate of the sample in the color space. Here, the L value indicates the lightness, the a value indicates the red or green value and the b value indicates the blue or yellow value. A reduction in brown or dark coloration becomes evident as a rule through an increase in the lightness, i.e. the L value, and a decrease in the red fraction, i.e. the a value. A further possibility for quantitatively determining the lightening is the so-called iodine color number according to DIN 6162.

The organic polyisocyanate obtainable by the process described above for lightening organic polyisocyanates with ozone-containing gases preferably has color values according to the CIELAB color system of L from 40 to 98, a from 10 to −10 and b from 40 to 90. In the measurements after carrying out the process, color values of L from 75 to 95, a from 3 to −10 and b from 65 to 70, in particular of L from 85 to 95, a from 0 to −10 and b from 65 to 70 were often found.

The isocyanate content and the color values of the polyisocyanates obtainable by the process described above were also investigated in experiments on the shelf-life. It was found that color and content of NCO groups of the isocyanates obtainable by the process described above do not change significantly at temperatures in the range from 25° C. to 100° C., in particular in the range from 25° C. to 60° C., and over a period of from 1 to 100 days, in particular from 1 to 95 days.

The organic polyisocyanate obtainable by the process described above does not have poorer physical or mechanical properties. The lightened polyisocyanate product was used in comparison with untreated polyisocyanate in the standard formulations for rigid polyurethane foams. It was found that substantially lighter polyurethane foams are obtained, the physical and mechanical characteristics not changing negatively.

The organic polyisocyanate, obtainable (or obtained) by the process described above, has experienced no detectable chain degradation during the process.

On treatment of, for example, PMDI with ozone or with oxygen, it is mechanistically conceivable that the methylene bridge between the aromatics will be oxidized and benzylic alcohols, hydroperoxides or ketones will be formed. In the lightened isocyanates, various chromatographic and spectroscopic methods, such as gel permeation chromatography coupled with Fourier transformation infrared spectroscopy (GPC-FTIR), high-pressure liquid chromatography after derivatization of the PMDI (HPLC), gas chromatography coupled with mass spectrometry (GC-MS) and nuclear magnetic resonance spectroscopy (NMR) and DSC (differential scanning calorimetry), could not detect any oxidation products which indicate that chain degradation at the methylene bridges of the PMDI has taken place.

The invention is explained in more detail by the following examples:

### EXAMPLE 1

### Laboratory Experiments

100 ml of a solution of PMDI and dichloromethane (1:5) were initially taken in a 500 ml three-necked flask having a magnetic stirrer bar, gas inlet tube, gas outlet tube and internal thermometer, under anhydrous conditions. A sample was taken from this sample and the initial color determined. Thereafter, cooling to −78° C. was effected under nitrogen with an isopropanol/dry ice mixture and stirring was effected for 10 minutes. Thereafter, oxygen having an ozone content of 0.5% and at a volume flow rate of 20 l/h was passed via the gas inlet tube for 2 minutes. After the introduction of ozone, flushing with nitrogen was effected for 10 minutes and the content allowed to warm up to room temperature. The sample was taken from the reaction mixture and the color determined.

A classical ozonizer (manufacturer, e.g. Fischer, Meckendorf, DE) was used for ozone preparation. Table 1 shows the color values before and after the treatment with the ozone-containing gas.

TABLE 1

| | Sample before | |
|---|---|---|
| Parameter | ozone treatment | Sample after ozone treatment |
| L* | 71.0 | 88.3 |
| a* | 4.0 | −8.0 |
| b* | 67.3 | 60.5 |
| Iodine color number | 34.3 | 14.2 |

### EXAMPLE 2

### Experiments on Shelf-Life

250 g of PMDI having a viscosity of 200 mPa·s were weighed under anhydrous conditions into a 300 ml gas wash bottle having an inlet tube with frit and magnetic stirrer bar. After thermostating at 60° C., ozone, produced from synthetic air, was passed in at a volume flow rate of 20 l/h. A commercially available ozonizer from Fischer was used for ozone preparation. After one hour, the ozonizer was switched off and flushing with pure synthetic air was effected for a further 10 minutes.

At the given volume flow rate, the ozonizer produced 360 mg of ozone in 20 l of synthetic air per hour. Furthermore, the ozone-containing gas also comprised nitrogen and nitrogen oxide. The content of absorbed ozone in PMDI in these experiments was 100.8 mg per hour. The experiment was then repeated under the same conditions. The inlet time of ozone was increased to 2 hours.

From the abovementioned experiments, shelf-life series were prepared and the samples stored at different temperatures and investigated after a certain time with regard to the stability of the color produced by lightening and long-term stability of the NCO groups.

In order to determine the shelf-life of PMDI having a viscosity of 200 mPa·s (25° C.) after ozonization, different storage temperatures (25, 35 and 60° C.) were specified. At each temperature, samples from the one-hour and two-hour ozone treatment were stored.

There are altogether 6 experimental series and each experimental series comprised 30 samples of 5 g each of treated PMDI. Each sample was packed in a sample tube with air-tight closure.

The initial values were: initial color: L*=40.3; a*=30.6; b*=43.2 and iodine color number=73.4. The initial NCO content was 30.3%.

Altogether, the shelf-lives were observed over a period of 93 days and all the values were determined by a double determination. It was found that the samples were stable with regard to color and NCO content.

TABLE 2
L* = 40.3; a* = 30.6; b* = 43.2; iodine color number = 73.4; NCO % = 30.3

| | | | 25° C. | 35° C. | 60° C. | 25° C. | 35° C. | 60° C. |
|---|---|---|---|---|---|---|---|---|
| | | | 1 h | 1 h | 1 h | 2 h | 2 h | 2 h |
| Time | | | ozonized | ozonized | ozonized | ozonized | ozonized | ozonized |
| 1st | day | L* | 83.7 | 81.9 | 79.5 | 84.3 | 83.8 | 82.1 |
| | | a* | 1 | 2.7 | 5 | 0.8 | 1 | 3.8 |
| | | b* | 77.2 | 76.8 | 76 | 79.7 | 78.5 | 85.1 |
| | | iodine | 25.7 | 27.5 | 29.8 | 26.6 | 26.3 | 33.3 |
| | | color number | | | | | | |
| | | NCO | 30.2 | 30.3 | 30.3 | 30.2 | 30.3 | 30.2 |
| 4th | day | L* | 82.7 | 82.8 | 79.3 | 84.4 | 83.2 | 80.9 |
| | | a* | 2.0 | 1.9 | 5.1 | 1.0 | 1.6 | 5.3 |
| | | b* | 79.2 | 79.1 | 76.7 | 80.4 | 79.9 | 86.2 |
| | | iodine | 28.1 | 27.9 | 30.5 | 27.3 | 28.1 | 36.0 |
| | | color number | | | | | | |
| | | NCO | 30.2 | 30.2 | 30.3 | 30.3 | 30.1 | 30.1 |
| 7th | day | L* | 82.9 | 81.5 | 79.2 | 83.1 | 83.1 | 80.8 |
| | | a* | 2.0 | 3.2 | 5.4 | 2.3 | 1.9 | 5.7 |
| | | b* | 79.7 | 78.8 | 77.8 | 83.0 | 80.4 | 87.0 |
| | | iodine | 28.1 | 29.3 | 31.6 | 30.3 | 28.3 | 36.8 |
| | | color number | | | | | | |
| | | NCO | 30.3 | 30.3 | 30.3 | 30.3 | 30.3 | 30.1 |
| 11th | day | L* | 82.0 | 81.0 | 80.1 | 84.0 | 82.8 | 80.8 |
| | | a* | 2.5 | 3.6 | 4.4 | 1.3 | 2.2 | 6.1 |
| | | b* | 81.9 | 80.2 | 77.0 | 81.2 | 81.3 | 88.1 |
| | | iodine | 30.8 | 30.8 | 29.8 | 27.9 | 29.5 | 38.0 |
| | | color number | | | | | | |
| | | NCO | 30.2 | 30.2 | 30.2 | 30.2 | 30.3 | 30.0 |
| 14th | day | L* | 83 | 81.6 | 80.2 | 83.5 | 82.5 | 80.8 |
| | | a* | 2.1 | 3.4 | 5 | 1.9 | 2.6 | 6.2 |
| | | b* | 80.4 | 79.5 | 79.1 | 82.6 | 82.1 | 88.3 |
| | | iodine | 28.6 | 29.8 | 31.3 | 29.5 | 30.5 | 38 |
| | | color number | | | | | | |
| | | NCO | 30.3 | 30.2 | 30.1 | 30.2 | 30.2 | 29.9 |
| 19th | day | L* | 82.7 | 80.6 | 82.0 | 83.5 | 81.8 | 81.8 |
| | | a* | 2.4 | 4.3 | 2.6 | 2.0 | 3.2 | 3.9 |
| | | b* | 81.1 | 81.7 | 77.4 | 82.7 | 83.7 | 82.9 |
| | | iodine | 29.5 | 32.7 | 27.7 | 29.8 | 32.4 | 31.9 |
| | | color number | | | | | | |
| | | NCO | 30.4 | 30.2 | 30.2 | 30.4 | 30.3 | 30.2 |
| 25th | day | L* | 83.0 | 82.6 | 81.4 | 76.9 | 81.0 | 80.7 |
| | | a* | 1.7 | 1.8 | 3.4 | 5.6 | 4.0 | 6.2 |
| | | b* | 80.4 | 78.5 | 80.0 | 86.7 | 84.7 | 88.6 |
| | | iodine | 28.6 | 27.7 | 30.3 | 43.1 | 34.6 | 38.4 |
| | | color number | | | | | | |
| | | NCO | 30.8 | 30.6 | 30.8 | 30.5 | 30.8 | 30.4 |
| 28th | day | L* | 82.3 | 80.7 | 80.5 | 83.3 | 81.8 | 80.8 |
| | | a* | 2.6 | 3.9 | 4.4 | 2.2 | 3.3 | 6.3 |
| | | b* | 82.1 | 81.5 | 81.2 | 83.6 | 83.6 | 89 |
| | | iodine | 30.8 | 32.4 | 32.4 | 30.5 | 32.4 | 38.8 |
| | | color number | | | | | | |
| | | NCO | 30.1 | 30.2 | 30.0 | 30.2 | 30.1 | 29.7 |
| 34th | day | L* | 82.5 | 81.3 | 80.9 | 83.0 | 82.0 | 80.2 |
| | | a* | 2.5 | 3.6 | 3.9 | 2.5 | 3.1 | 6.3 |
| | | b* | 81.7 | 83.3 | 81.4 | 83.9 | 84.0 | 88.7 |
| | | iodine | 30 | 32.7 | 32.2 | 31.3 | 32.4 | 39.7 |
| | | color number | | | | | | |
| | | NCO | 30.2 | 30.2 | 30.0 | 30.2 | 30.2 | 29.7 |
| 43rd | day | L* | 82.2 | 80.1 | 81.0 | 83.1 | 81.3 | 80.3 |
| | | a* | 2.7 | 4.3 | 3.7 | 2.3 | 3.9 | 6.7 |
| | | b* | 82.3 | 81.7 | 82.2 | 83.9 | 84.5 | 89.9 |
| | | iodine | 30.8 | 33.3 | 32.4 | 31.0 | 34.0 | 40.6 |
| | | color number | | | | | | |
| | | NCO | 30.2 | 30.2 | 29.9 | 30.3 | 29.3 | 29.6 |
| 49th | day | L* | 81.8 | 82.0 | 81.0 | 80.5 | 80.3 | 80.1 |
| | | a* | 3.2 | 2.8 | 2.9 | 6.3 | 6.7 | 6.7 |
| | | b* | 83.5 | 78.4 | 78.5 | 89.8 | 89.9 | 89.7 |
| | | iodine | 32.4 | 28.7 | 28.1 | 40.1 | 40.6 | 39.4 |
| | | color number | | | | | | |
| | | NCO | 30.0 | 30.1 | 29.9 | 29.5 | 30.1 | 30.7 |
| 63rd | day | L* | 81.6 | 80.2 | 80.9 | 81.9 | 80.5 | 79.8 |
| | | a* | 3.4 | 4.5 | 3.8 | 3.4 | 5.9 | 7.6 |
| | | b* | 84 | 83.3 | 83.2 | 84.9 | 90.2 | 91.6 |
| | | iodine | 33 | 34.6 | 33.3 | 30 | 40.6 | 43.1 |
| | | color number | | | | | | |
| | | NCO | 29.9 | 29.8 | 29.2 | 30.3 | 29.8 | 29.9 |
| 74th | day | L* | 81.3 | 80.7 | 81.3 | 79.9 | 82.3 | 80.8 |
| | | a* | 3.6 | 4.0 | 3.1 | 4.7 | 3.2 | 5.8 |
| | | b* | 84.3 | 84.1 | 82.7 | 85.6 | 85.4 | 89.9 |
| | | iodine | 33.7 | 34.3 | 32.4 | 37.2 | 33.3 | 39.7 |
| | | color number | | | | | | |
| | | NCO | 29.8 | 30.2 | 30.0 | 29.9 | 29.9 | 30.0 |
| 83rd | day | L* | 80.7 | 80.3 | 81.1 | 81.8 | 80.1 | 79.5 |
| | | a* | 4.1 | 4.3 | 3.7 | 3.8 | 4.7 | 7.6 |
| | | b* | 85.2 | 83.5 | 84.3 | 86.7 | 85.7 | 92.2 |
| | | iodine | 35.3 | 34.6 | 34.0 | 35 | 36.8 | 44.7 |
| | | color number | | | | | | |
| | | NCO | 30.2 | 30.1 | 29.4 | 30.2 | 29.9 | 29.9 |
| 92nd | day | L* | 81 | 76.9 | 80.3 | 82.2 | 80.3 | 79.3 |
| | | a* | 3.9 | 5.6 | 4.2 | 3.3 | 4.5 | 8.1 |
| | | b* | 84.7 | 85.5 | 84.7 | 86.4 | 85.7 | 93.2 |
| | | iodine | 34.6 | 42.0 | 35.7 | 34 | 36.4 | 45.9 |
| | | color number | | | | | | |
| | | NCO | 30.1 | 30.2 | 30.1 | 30.1 | 30.0 | 30 |

### EXAMPLE 3

### Ozonization in Batch Operation in a Stirred Tank

### Experimental Setup:

An ozone generator (manufacturer SORBIUS (Berlin) GSF 010.2) was used for producing the required amount of ozone. In the experiments, pure oxygen of quality 3.5 was used as working gas. To avoid working under an oxygen atmosphere, nitrogen having the quality 5.0 was passed into the gas phase of the reactor vessel in all experiments. It was ensured that the volume flow rate of the nitrogen was four times the oxygen volume flow rate at all times. The volume flow rates of the working gases were determined using rotameters and the ozone concentration of the oxygen after the ozonizer was determined by UV absorption and stated in mg/l. In order to be able to determine the amount of ozone which had reacted, the ozone concentration of the outflowing oxygen/nitrogen mixture was determined. After the ozone measuring apparatus, a cascade of four wash bottles with a KOH/KI solution was connected in order to absorb excess ozone and oxides of nitrogen.

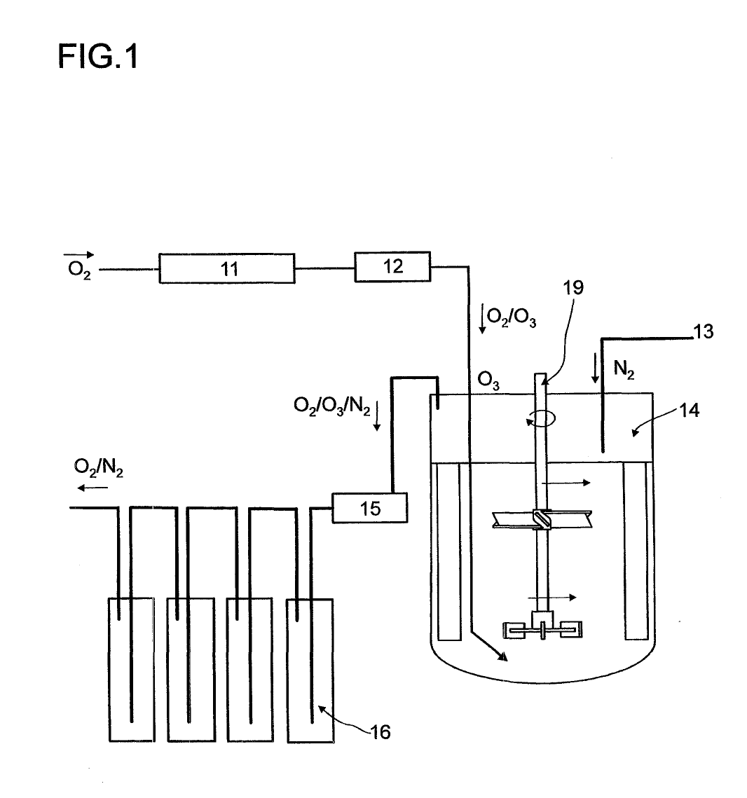

The reactor was heated by a jacket heater and operated with a specially produced turbine stirrer which made it possible to stir unreacted ozone which had escaped from the reaction mixture and originated from the gas phase back into the reaction mixture. In order to achieve ideal dispersing of the gas, a baffle was additionally installed. The ozone concentration could be adjusted at the ozone generator by a power regulator, and the power input of the stirrer could be fixed using a controllable stirring unit. FIG. 1 shows a schematic diagram of a batch plant (stirred tank) in which the polyisocyanate can be treated with ozone-containing gas with nitrogen flushing.

### Experimental Procedures:

7.2 kg of PMDI having a viscosity of 200 mPa·s and an initial color of: L*=53.9; a*=21.8; b*=43.5 and iodine color number=39.7 were weighed into the reactor under a nitrogen atmosphere. The initial NCO content was 30.3%. After thermostating at 22° C., oxygen was passed in for 30 minutes at a volume flow rate of 25 l/h with an ozone concentration of 100 mg/l. At the same time, the volume flow rate of nitrogen was 100 l/h so that the oxygen concentration in the reactor was never above 20%. The ozone concentration was measured at the ozone measuring apparatus after the reactor and the value was multiplied by 5 since the dilution factor had to be taken into account. The amount of ozone which had reacted was calculated after the reaction via the volume flow rates as a function of time and concentration. The stirring speeds were chosen so that the power input was 5.0 kW/m³. 142 mg of ozone/kg of PMDI were reacted; this corresponds to an ozone conversion of 81%. The following color numbers were achieved: L*=79.5; a*=4.1; b*=59.8 and iodine color number=20.1. The NCO content after the experiment was 30.3%.

### EXAMPLE 4

### Ozonization in Batch Operation in a Stirred Tank

The experimental setup was chosen as in example 3.

The procedure was as in example 3, but the temperature was kept at 40° C. 146 mg of ozone/kg of PMDI were reacted; this corresponds to an ozone conversion of 83%.

The following color numbers were achieved: L*=80.8; a*=3.1; b*=61.2 and iodine color number=19.6.

The NCO content after the experiment was 30.3%.

### EXAMPLE 5

### Ozonization in Batch Operation in a Stirred Tank

The experimental setup was chosen as in example 3.

The procedure was as in example 3, but the temperature was kept at 60° C. 166 mg of ozone/kg of PMDI were reacted; this corresponds to an ozone conversion of 95%.

The following color numbers were achieved: L*=81.1; a*=3.2; b*=61.2 and iodine color number=21.2.

The NCO content after the experiment was 30.3%.

### EXAMPLE 6

### Ozonization in Batch Operation in a Stirred Tank

The experimental setup was chosen as in example 3.

The procedure was as in example 3 but the oxygen volume flow rate was kept at 50 l/h and the nitrogen flow rate at 200 l/h. 239 mg of ozone/kg of PMDI were reacted; this corresponds to an ozone conversion of 70%.

The following color numbers were achieved: L*=84.2 a*=−0.7; b*=64.4 and iodine color number=18.3.

The NCO content after the experiment was 30.3%.

### EXAMPLE 7

### Ozonization in Batch Operation in a Stirred Tank

The experimental setup was as in example 3.

The procedure was as in example 6 but the temperature was kept at 60° C. 313 mg of ozone/kg of PMDI were reacted; this corresponds to an ozone conversion of 90%.

The following color numbers were achieved: L*=84.8; a*=−0.5; b*=68.1 and iodine color number=19.6.

The NCO content after the experiment was 30.3%.

### EXAMPLE 8

### Ozonization in Batch Operation in a Stirred Tank

The experimental setup was chosen as in example 3.

The procedure was as in example 6 but the energy input by the stirrer was reduced to 1.0 kW/m³ and the temperature was kept at 60° C. 276 mg of ozone/kg of PMDI were reacted; this corresponds to an ozone conversion of 79%.

The following color numbers were achieved: L*=81.1; a*=3.3; b*=65.5 and iodine color number=21.6.

The NCO content after the experiment was 30.3%.

### EXAMPLE 9

### Ozonization in Batch Operation in a Stirred Tank

The experimental setup was chosen as in example 3.

7.2 kg of PMDI having a viscosity of 200 m*Pas and an initial color of: L*=53.9; a*=21.8; b*=43.5 and iodine color number=39.7 were weighed into the reactor under a nitrogen atmosphere. After thermostating at 60° C., nitrogen was passed in for 30 minutes with a volume flow rate of 25 l/h with an ozone concentration of 120 mg/l. At the same time, the volume flow rate of nitrogen was 100 l/h so that the oxygen concentration in the reactor was never above 20%. The ozone concentration was measured at the ozone measuring apparatus after the reactor and the value was multiplied by 5 since the dilution factor had to be taken into account. The amount of ozone which had reacted was calculated after the reaction via the volume flow rates as a function of time and concentration. The stirrer speed was chosen so that the power input was 1.0 kW/m³. 155 mg of ozone/kg of PMDI were reacted; this corresponds to an ozone conversion of 74%.

The following color numbers were achieved: L*=77.8; a*=8.5; b*=59.2 and iodine color number=23.8.

The NCO content after the experiment was 30.3%.

### EXAMPLE 10

### Ozonization in Batch Operation in a Stirred Tank

The experimental setup was chosen as in example 3.

The procedure was as in example 9 but the energy input by the stirrer was kept at 2.0 kW/m³. 166 mg of ozone/kg of PMDI were reacted; this corresponds to an ozone conversion of 85%.

The following color numbers were achieved: L*=80.7; a*=5.2; b*=61.7 and iodine color number=21.5.

The NCO content after the experiment was 30.3%.

### EXAMPLE 11

### Ozonization in Batch Operation in a Stirred Tank

The experimental setup was chosen as in example 3.

The procedure was as in example 9 but the energy input by the stirrer was kept at 3.0 kW/m³. 184 mg of ozone/kg of PMDI were reacted; this corresponds to an ozone conversion of 90%. The following color numbers were achieved: L*=81.4; a*=4.6; b*=63.5 and iodine color number=22. The NCO content after the experiment was 30.3%.

### EXAMPLE 12

### Ozonization in Batch Operation in a Stirred Tank

The experimental setup was chosen as in example 3.

The procedure was as in example 9 but the energy input by the stirrer was kept at 4.0 kW/m³. 187 mg of ozone/kg of PMDI were reacted; this corresponds to an ozone conversion of 92%.

The following color numbers were achieved: L*=81.9; a*=4.8; b*=61.9 and iodine color number=21.2.

The NCO content after the experiment was 30.3%.

### EXAMPLE 13

### Ozonization in Batch Operation in a Stirred Tank

The experimental setup was chosen as in example 3.

The procedure was as in example 9 but the energy input by the stirrer was kept at 5.0 kW/m³. 187 mg of ozone/kg of PMDI were reacted; this corresponds to an ozone conversion of 94%.

The following color numbers were achieved: L*=82.8; a*=15; b*=64.5 and iodine color number=19.5.

The NCO content after the experiment was 30.3%.

### EXAMPLE 14

### Ozonization in Batch Operation in a Stirred Tank

The experimental setup was chosen as in example 3.

7.2 kg of PMDI having a viscosity of 200 m*Pas and an initial color of: L*=86.3; a*=−2.8; b*=42.3 and iodine color number=10.0 were weighed into the reactor under a nitrogen atmosphere. The additional NCO content was 30.7%. After thermostating at 60° C., nitrogen was passed in for 45 minutes with a volume flow rate of 25 l/h with an ozone concentration of 100 mg/l. At the same time, the volume flow rate of nitrogen was 100 l/h so that the oxygen concentration in the reactor was never above 20%. The ozone concentration was measured at the ozone measuring apparatus after the reactor and the value was multiplied by 5 since the dilution factor had to be taken into account. The amount of ozone which had reacted was calculated after the reaction via the volume flow rates as a function of time and concentration. The stirrer speeds were chosen so that the power input was 3.0 kW/m³. 250 mg of ozone/kg of PMDI were reacted; this corresponds to an ozone conversion of 91.7%.

The following color numbers were achieved: L*=93.4; a*=−8.7; b*=54.5 and iodine color number=10.0.

The NCO content after the experiment was 30.7%.

### EXAMPLE 15

### Ozonization in Batch Operation in a Stirred Tank

The experimental setup was chosen as in example 3.

The procedure was as in example 14 but the stirrer from example 16 was used. 242 mg of ozone/kg of PMDI were reacted; this corresponds to an ozone conversion of 92.3%.

The following color numbers were achieved: L*=93.3; a*=−8.6; b*=54.6 and iodine color number=10.0.

The NCO content after the experiment was 30.7%.

### EXAMPLE 16

### Ozonization in a Stirred Tank with Quasi-Continuous Reaction Procedure

### Experimental Setup:

An ozone generator (manufacturer SORBIUS GSF 010.2) was used for producing the required amount of ozone. In the experiments, pure oxygen of quality 3.5 was used as working gas. To avoid working under an oxygen atmosphere, nitrogen having the quality 5.0 was passed into the gas phase of the reactor vessel in all experiments. It was ensured that the volume flow rate of the nitrogen was four times the oxygen volume flow rate at all times. The volume flow rates of the working gases were determined using rotameters and the ozone concentration of the oxygen after the ozonizer was determined by UV absorption and stated in mg/l. In order to be able to determine the amount of ozone which had reacted, the ozone concentration of the outflowing oxygen/nitrogen mixture was determined.

After the ozone measuring apparatus, a cascade of four wash bottles with a KOH/KI solution was connected in order to absorb excess ozone and oxides of nitrogen. The reactor was heated by a jacket heater and was operated with a four-blade stirrer. In order to achieve ideal dispersing of the gas, a baffle was installed.

The ozone concentration could be adjusted at the ozone generator by a bioregulator, and the power input of the stirrer could be fixed by means of a controllable stirring unit. In order to be able to ozonize a large amount of PMDI in a short time, a storage tank in the form of a 120 l drum which was equipped with a stirrer in order to guarantee good mixing was additionally simulated. The storage tank was connected via two pipes and two pumps to the reactor so that continuous circulation between the reactor and the storage tank was possible.

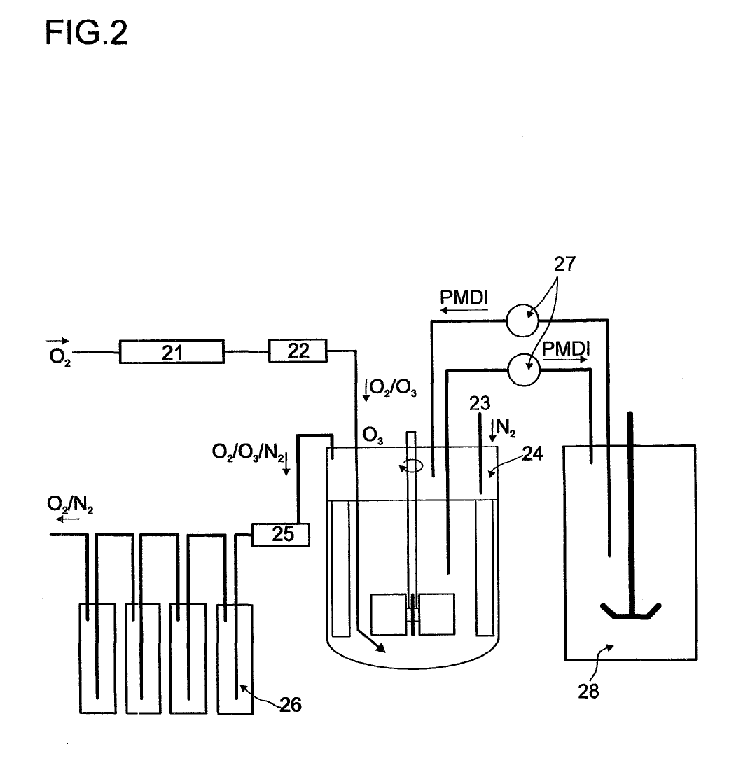

FIG. 2 schematically shows an apparatus in which a reactor with stirring units is connected via two pipelines with pumps to a storage tank.

### Experimental Procedures:

7.2 kg of PMDI having a viscosity of 200 mPa·s and an initial color of: L*=84.9; a*=−1.9; b*=42.3 and iodine color number=10.6 were weighed into the reactor under a nitrogen atmosphere. The initial NCO content was 30.7%. 77.7 kg of PMDI of the same quality were weighed into the storage container. Thereafter, the two pumps were adjusted to a rate of 9.8 kg of PMDI per hour. After thermostating at 35° C., oxygen was passed into the reactor at a volume flow rate of 25 l/h and with an ozone concentration of 100 mg/l. At the same time, the volume flow rate of nitrogen was 100 l/h so that the oxygen concentration in the reactor never exceeded 20%. The ozone concentration values of the ozone measuring apparatus after the reactor were then multiplied by 5 since the dilution factor had to be taken into account.

The amount of ozone reacted could be calculated after the reaction via the volume flow rates as a function of time and concentration. The stirring speed of the four-blade stirrer in the reactor was chosen so that the power input was 3.0 kW/m³. The stirrer in the storage container was operated at low power in order to ensure uniform thorough mixing. The apparatus was then allowed to operate for 10 hours under the set conditions.

In the experiments carried out, 217 mg of ozone per kg of PMDI were reacted. Color numbers of: L*=92.3; a*=−7.9; b*=53.9 and iodine color number=10.3 were achieved with unchanged NCO contents. In this way, a total amount of 25.77 g of ozone were passed in and 18.42 g were converted for a total amount of 85 kg of PMDI.

### EXAMPLE 16A

### Ozonization with Continuous Reaction Procedure

2 kg of PMDI having a viscosity of 200 mPa·s and an initial color of: L*=3.9; a*=21.8; b*=43.5 and iodine color number=39.7 were weighed into the reactor under a nitrogen atmosphere. 83 kg of PMDI of the same quality were weighed into the storage container. The subsequent procedure was as in example 16. The apparatus was then allowed to operate for 10 hours under the set conditions. In the experiments carried out, 232 mg of ozone per kg of PMDI were reacted and color numbers of: L*=81.6; a*=2.4; b*=68.6 and iodine color number=22.7 were achieved with unchanged NCO contents.

### EXAMPLE 16B

### Completely Continuous Ozonization in a Stirred Tank

### Experimental Setup:

The experimental setup corresponds to that described in example 16, except that the pump which delivers into the 120 liter drum delivers into a separate storage container here.

### Experimental Procedures:

2 kg of PMDI having a viscosity of 200 mPa·s and an initial color of: L*=53.9; a*=21.8; b*=43.5 and iodine color number=39.7 were weighed into the reactor under a nitrogen atmosphere. 83 kg of PMDI of the same quality were weighed into the storage container. The two pumps were then adjusted to a rate of 9.8 kg of PMDI per hour. After thermostating at 35° C., oxygen was passed into the reactor at a volume flow rate of 25 l/h and with an ozone concentration of 100 mg/l. At the same time, the volume flow rate of nitrogen was 100 l/h so that the oxygen concentration in the reactor never exceeded 20%. The ozone concentration values of the ozone measuring apparatus after the reactor were then multiplied by 5 since the dilution factor had to be taken into account. The amount of ozone reacted could be calculated after the reaction via the volume flow rates as a function of time and concentration. The stirring speed of the four-blade stirrer of the reactor was chosen so that the power input was 10 W/dm³. The stirrer in the storage container was operated at low power in order to ensure uniform thorough mixing. In the experiments carried out, 210 mg of ozone were reacted per kg of PMDI and color numbers of: L*=81.3; a*=1.8; b*=64.0 and iodine color number=20.6 were achieved with unchanged NCO contents.

### EXAMPLE 16C

### Completely Continuous Ozonization in a Stirred Tank

The experimental setup was chosen as in example 16B.

The experiment was carried out as in example 16B, except that the pumping rates were reduced to 3.3 kg/h. In the experiments carried out, 610 mg of ozone per kg of PMDI were reacted and color numbers of: L*=85.5; a*=−1.7; b*=69.0 and iodine color number=19.5 were achieved with unchanged NCO contents.

### EXAMPLE 17

### Ozonization in Sieve Tray Column-Continuous Reaction

### Experimental Setup:

An ozone generator from Fischer was used for producing the required amount of ozone. In the experiments, hydrocarbon-free synthetic air (20% of oxygen and 80% of nitrogen) was used as working gas. The volume flow rate of the working gas was determined using a rotameter and the ozone concentration of the working gas was determined iodometrically. The ozone-containing air was passed from below at a volume flow rate of 20 l/h through a column having sieve trays and overflows. The column had a length of 83 cm, and a diameter of 3.5 cm and was equipped with 20 sieve trays. A continuous feed of PMDI (750 g/h) having a viscosity of 200 mPa·s was pumped from above in a direction opposite to the gas stream. After the column, a cascade of four wash bottles with a KOH/KI solution was connected in order to absorb excess ozone and oxides of nitrogen. The column was heated to 60° C. by means of a jacket heater. The ozone concentration could be adjusted at the ozone generator by a power regulator. In order to be able to ozonize a large amount of PMDI in a short time, a storage vessel in the form of a 5 l container was additionally installed before the PMDI pump and, at the bottom of the column, the outflow was fitted with a 5 l collecting container via a hose.

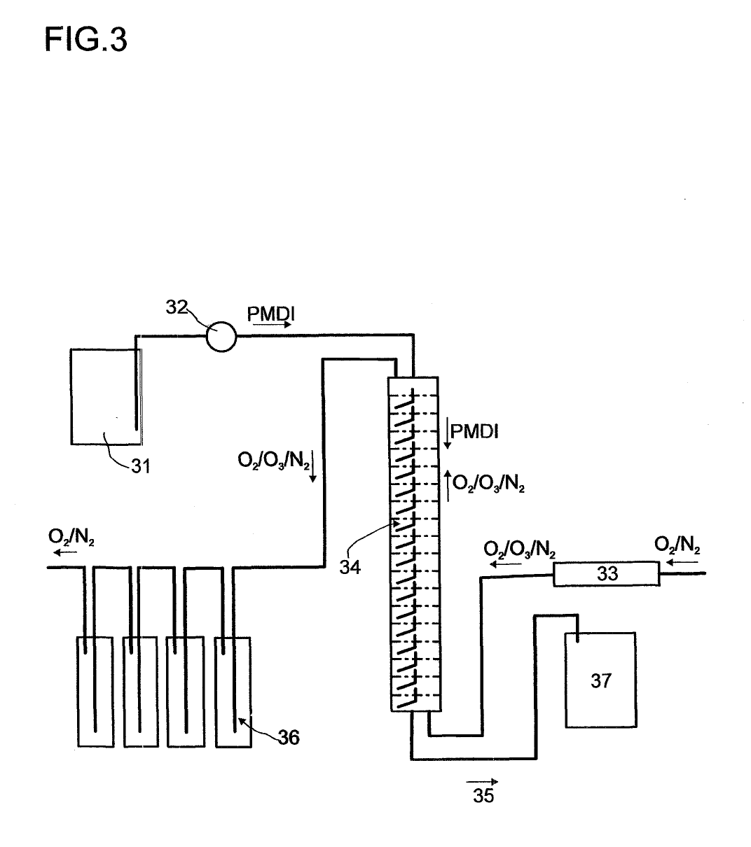

FIG. 3 shows a column having sieve trays in which the process according to the invention can be carried out completely continuously. The feed of the ozone-containing gas from below is visible, while the starting material (PMDI) is fed into the column from above.

### Experimental Procedure:

5 kg of PMDI having a viscosity of 200 mPa·s (25° C.) were weighed into the storage container 1 and thermostated at 60° C. Thereafter, the pump was put into operation and the complete column, which was heated to 60° C., was filled from above. After PMDI had reached the collecting container 2, an ozone-oxygen-nitrogen mixture was passed via the ozone generator at a volume flow rate of 20 l/h into the column (360 mg of ozone per hour). The PMDI pump was adjusted so that 750 g of PMDI per hour were passed through the column. After steady-state conditions were reached, operation was maintained continuously for 3 h. The PMDI used had an initial color of: L*=53.9; a*=21.8; b*=43.5 and iodine color number=39.7 and it was possible to improve the color to: L*=86.6; a*=−1.9; b*=69.7 and iodine color number=18.7. With this experimental arrangement, it was possible to convert the complete amount of altogether 1.08 g of ozone produced into PMDI. This corresponds to 480 mg of ozone per kg of PMDI.

### EXAMPLE 18

### Ozonization in a Packed Column, Continuous Reaction

An ozone generator from Fischer was used for producing the required amount of ozone. In the experiments, hydrocarbon-free synthetic air was used as working gas. The volume flow rate of the working gas was determined using a rotameter and the ozone concentration of the working gas was determined iodometrically. The ozone-containing air was fed via a dip tube to the bottom of the column and passed with a volume flow rate of 20 l/h through the packed column, which was filled with Raschig rings. The packing height was 28 cm and the diameter was 7.0 cm. A continuous feed of PMDI (500 g/h) having a viscosity of 200 mPa·s was pumped from above in the opposite direction to the gas stream. After the column, a cascade of four wash bottles with a KOH/KI solution was connected in order to absorb excess ozone and oxides of nitrogen. The column was heated to 60° C. by means of a jacket heater. The ozone concentration could be adjusted at the ozone generator by a power regulator. In order to be able to ozonize a large amount of PMDI in a short time, a storage vessel in the form of a 5 l container was additionally installed before the PMDI pump and, at the bottom of the column, the outflow was fitted with a 5 l collecting container via a hose.

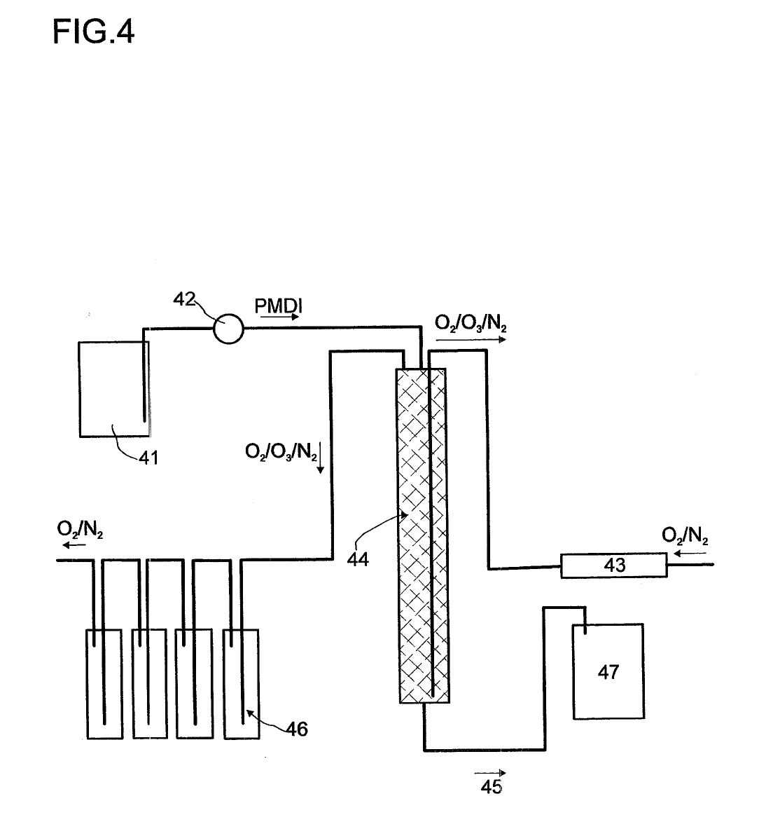

FIG. 4 shows a column filled with Raschig rings for treating polyisocyanates with ozone-containing gas. The PMDI is fed in from above and the ozone-containing gas is passed in countercurrently.

### Experimental Procedure:

5 kg of PMDI having a viscosity of 200 mPa·s (25° C.) were weighed into the storage container 1 and thermostated at 60° C. Thereafter, the pump was put into operation and the complete column, which was heated to 60° C., was filled from above. After PMDI had reached the collecting container 2, an ozone-oxygen-nitrogen mixture was passed via the ozone generator with a volume flow rate of 20 l/h into the column (360 mg of ozone per hour). The PMDI pump was adjusted so that 500 g of PMDI per hour were passed through the column. After steady-state conditions were reached, operation was maintained for 3 h continuously.

The PMDI used had an initial color of L*=53.9; a*=21.8; b*=43.5 and iodine color number=39.7, and it was possible to improve the color to: L*=86.6; a*=−1.9; b*=69.7 and iodine color number=18.7.

### EXAMPLE 19

### Use of PMDI Samples in Foam Tests

PMDI samples from example 14 were used in a standard rigid foam system.

### Amounts of Ozone Reacted:

PMDI 1: 253 mg/kg with 92% ozone conversion
PMDI 2: 250 mg/kg with 92% ozone conversion.

The PMDI samples provided were used in a standard formulation for rigid polyurethane foams. Table 3 shows the composition of component A of the formulation. Component B was the polyisocyanate stated in each case.

TABLE 3

| Component A | Parts (% by weight) |
|---|---|
| Sacc./glycerol-initiated Peol with OHN | 53.3 |
| (OH number) of 490 | |
| PG-initiated Peol with OHN of 105 | 23.9 |
| Glycerol | 1.4 |
| Water | 2.4 |
| Tegostab (from Degussa) | 1.0 |
| Dimethylcyclohexylamine | 2.4 |
| 1,1-Dichloro-1-fluoroethene | 15.5 |

The results for the characteristics of the polyurethane foams obtained are summarized in table 4 below.

TABLE 4

| | | | | | Lupranat |
|---|---|---|---|---|---|
| | | | Ozonized | Ozonized | M20S |
| | PMDI 1 | PMDI 2 | PMDI 1 | PMDI 2 | comparison |
| Isocyanate | | | | | |
| NCO content (%) | 30.3 | 30.7 | 30.3 | 30.7 | 31.2 |
| Iodine color number | 39.7 | 10.0 | 19.7 | 10.0 | 15.6 |
| L* | 53.9 | 86.3 | 83.5 | 93.4 | 88.0 |
| a* | 21.8 | −2.8 | 0.8 | −8.7 | −4.7 |
| b* | 43.5 | 42.3 | 65.9 | 54.5 | 63.9 |
| BV (40 g batch) | | | | | |
| Mixing ratio | 100:125 | 100:125 | 100:125 | 100:125 | 100:125 |
| comp. A:comp. B | | | | | |
| Index | 108.8 | 110.2 | 110.6 | 110.2 | 112.0 |
| RZ(s) | | | | | |
| Setting time | 54 | 55 | 53 | 55 | 52 |
| Rise time | 90 | 90 | 90 | 90 | 92 |
| Density (kg/m³) | 27.5 | 27.3 | 27.6 | 27.6 | 27 |
| Remark | Structure | Structure | Structure | Structure | Structure |
| | o.k. | o.k. | o.k. | o.k. | o.k. |
| Color | Gray | Lighter | Shade darker | Comparable | |
| | shade | than PMDI | than M20S | with M20S | |

The overview table shows that there are no significant differences in the measurable characteristics.

Analytical Investigations of the Ozone-Treated PMDI in Comparison with Untreated PMDI:

In the treatment of PMDI with ozone or oxygen, it was conceivable that the methylene bridge which links the aromatics is oxidized and forms benzylic alcohols, hydroperoxides or ketones. For this reason, spectroscopic methods were used to search for oxidation products in treated PMDI and the spectra of the methods of analysis were compared with the spectra of untreated PMDI.

### Overview of the Methods of Analysis Used:

GPC-FTIR (gel permeation chromatography coupled with Fourier transformation infrared spectroscopy)
DSC (differential scanning calorimetry)
HPLC (high-pressure liquid chromatography after derivatization of the PMDI)
GC-MS (gas chromatography coupled with mass spectrometry)
NMR (nuclear magnetic resonance spectroscopy)

### GPC-FTIR:

With the aid of this method, the nucleus distribution and important functional groups can be identified. The spectra obtained for treated and untreated PMDI were compared and it was found that the spectra coincided. This means that neither the nucleus distribution has changed nor is it possible to establish a change in the functional groups.

### DSC Measurements:

One sample with ozonized PMDI and one sample with untreated PMDI were investigated. It was found that the quantity of heat liberated in the measurement by both samples was identical within the accuracy of measurement. Thus, it was possible to rule out that the PMDI has changed significantly during the ozone treatment.

### HPLC:

One sample with ozonized PMDI and one sample with untreated PMDI were investigated. The samples were converted into the corresponding urethanes with ethanol before the investigation and then separated and detected via HPLC. The results showed no difference in the nucleus distribution of the two samples.

### GC-MS:

One sample with ozonized PMDI and one sample with untreated PMDI were investigated. In the GC-MS analysis, the focus was mainly on the oligomers having relatively low molar masses. The results showed no difference especially with regard to the oxidized species.

### NMR Spectroscopy:

The ¹H- and ¹³C-NMR spectra of the ozonized and nonozonized PMDI samples showed no difference. This means that no change of the isocyanates which is measurable in the NMR occurred during the ozonization.

The invention is also explained in more detail by the drawings.

FIG. 1 shows an apparatus (experimental setup) for batch ozonization in a stirred tank. An oxygen stream (as shown in FIG. 1) or an oxygen-containing gas is passed into the ozone production unit 11. In the measuring apparatus 12, the ozone concentration of the inflowing gas is determined before it is passed into the stirred tank 14. In addition, a nitrogen stream 13 is passed into the stirred tank 14, which is equipped with a stirring unit 19. By means of the measuring apparatus 15, the ozone concentration in the outflowing gas stream is determined. The exit gas purification unit 16 serves for deozonization of the emerging gas stream.

FIG. 2 shows an experimental setup for the quasi-continuous ozonization in a stirred tank. An oxygen stream (as shown in FIG. 2) or an oxygen-containing gas is passed into the ozone production unit 21. In the measuring apparatus 22, the ozone concentration of the inflowing gas is determined before it is passed into the stirred tank 24. In addition, a nitrogen stream 23 is passed into the stirred tank 24, which is equipped with a stirring unit. The reactor content is circulated via two pumps 27 between the reactor 24 and the connected storage tank 28. By means of the measuring apparatus 25, the ozone concentration in the outflowing gas mixture is determined. The exit gas purification unit 26 serves for deozonization of the emerging gas stream.

FIG. 3 shows an experimental setup for continuous ozonization in a sieve tray column with overflow. A gas stream comprising nitrogen and oxygen (as shown in FIG. 3) or another oxygen-containing gas is passed into the ozone production unit 33. The gas stream emerging from the ozone production unit 33 is passed from below into the sieve tray column with overflow 34 and removed at the upper end of the column. The emerging gas stream is fed through the exit gas purification unit 36 for deozonization. The PMDI is passed from a storage tank 31 by means of a pump 32 countercurrently from above into the column. The treated PMDI 35 is passed into a storage tank 37 at the lower end of the column.

FIG. 4 shows the experimental setup for continuous ozonization in a packed column. A gas stream comprising nitrogen and oxygen (as shown in FIG. 4) or another oxygen-containing gas is passed into the ozone production unit 43. The gas stream emerging from the ozone production unit 43 is passed from below into the packing column 44 and removed at the upper end of the column. The emerging gas stream is fed through the exit gas purification unit 46 for deozonization. The PMDI is passed from a storage tank 41 by means of a pump 42 countercurrently from above into the column. The treated PMDI 35 is passed into a storage tank 47 at the lower end of the column.

1-14. (canceled)

15. A process for lightening an organic polyisocyanate with ozone-containing gas, the process comprising contacting the organic polyisocyanate with a gas mixture comprising an ozone-comprising gas and at least one further inert and/or reactive gas, wherein the process is carried out continuously or quasi-continuously.

16. The process according to claim 15, wherein the contacting is carried out in a stirred tank with connected storage tank.

17. The process according to claim 15, wherein the contacting is carried out in a tray column.

18. The process according to claim 15, wherein the contacting is carried out in a packed column.

19. The process according to claim 15, wherein the gas mixture comprises nitrogen, oxygen, ozone, and at least one oxide of nitrogen.

20. The process according to claim 15, wherein the ozone-comprising gas is obtained from a working gas consisting of oxygen and nitrogen.

21. The process according to claim 15, wherein the ozone-comprising gas is obtained from a working gas consisting of 20% of oxygen and 80% of nitrogen.

22. The process according to claim 15, wherein the contacting is carried out at temperatures of from 15° C. to 100° C.

23. The process according to claim 16, wherein an energy input of a stirring unit is from 0.1 to 50 kW/m³.

24. The process according to claim 16, wherein a continuous circulation takes place between the stirred tank and the storage tank.

25. The process according to claim 15, wherein the contacting takes place in a stirred tank in which less than 50% of a volume of the stirred tank is filled with polyisocyanate.

26. The process according to claim 15, wherein surface aeration is effected during the contacting.

27. An organic polyisocyanate obtained by the process according to claim 15.

28. A polyurethane obtained by reacting an organic polyisocyanate obtained by the process according to claim 15 with an aliphatic or aromatic polyalcohol.

29. A polyurethane obtained by reacting an organic polyisocyanate obtained by the process according to claim 15 an aliphatic polyalcohol.

30. A shaped article comprising polyurethane obtained by reacting an organic polyisocyanate obtained by the process according to claim 15 with an aliphatic or aromatic polyalcohol.

31. A method for preparing a rigid polyurethane foam, the method comprising reacting an organic polyisocyanate obtained by the process according to claim 15 with an aliphatic or aromatic polyalcohol.

32. The process according to claim 15, wherein the ozone-comprising gas is obtained from a working gas comprising oxygen and nitrogen.
